(19) United States
(12) Patent Application Publication
(10) Pub. No.: US 2006/0230333 A1
(43) Pub. Date: Oct. 12, 2006

(54) Creating associated content for a region of a document in response to a user selecting the region

(75) Inventors: Dean Anthony Racovolis, Redmond, WA (US); Steven Harris Mitchell, Tumwater, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/100,711

(22) Filed: Apr. 7, 2005

(51) Int. Cl. G06F 17/00

(52) U.S. Cl. 715/500.1

(57) ABSTRACT

Described herein are systems and methods for enabling a user to select a region within a document, and to specify the creation of content to link to the selected region. The user also may be enabled to specify to access and/or modify already-existing associated content linked to the selected region. In response to the user specifying to create, access (e.g., read-only) or edit a region within the document, a separate window may be launched that enables the user to access, create and/or edit the associated content. This separate window may be a pane or panel within a user interface display of the application within which the document is being edited (i.e., an internal window), or may be a window external to the user interface display.

### BACKGROUND

Documents often include large amounts of information for the purpose of being precise and/or thorough, but often at the expense of clarity and brevity. For example, “form” documents often include significant amounts of information to assist a user in filling out the form. Although intended to assist persons, the amount of information often overwhelms and confuses a person. Some persons delete all of the assistance information so they can actually “see” and understand the form, while others take significantly longer to navigate their way through the form than they would otherwise take absent the assistance information.

To relieve persons of having to read too much information within the context of a main body of a document, documents often include appendices, footnotes, glossaries, attachments, etc. In the software arena, other mechanisms are available. Many software applications today enable users to link selected locations within a document to related content. For example, some applications enable users to insert hyperlinks in a document such as a hyper-text mark-up language (HTML) document such as a web page or a word processing document such as a Microsoft® word document. The author of such a document can use hyperlinks to offer readers links to related content outside of (i.e., located externally to) the document itself. For example, the document may be a news article on a website that includes hyperlinks to related articles on other websites.

Other software applications may be configured to implement smart tags. Smart tags define content (e.g., one or more words, strings of words, expressions, etc.) and associate one or more actions with this content. Typically, the content is related to a business entity for which the smart tag was created. For example, a sporting goods company may create a smart tag specifying content that includes terms like basketball, football, hockey, baseball, soccer, etc. The action defined by the smart tag may be to link a user to the sporting goods company's website.

An application (e.g., Microsoft® Word or Microsoft® Internet Explorer) may be configured to apply one or more smart tags when a document is opened and/or modified. Such an application will compare the content of the document to each of the one or more smart tags with which it is configured. When content (e.g., a word) of the document matches content (e.g., a word) of the smart tag, the content of the document may be marked is some fashion (e.g., underlined or highlighted). The user then may select the word and take one or more actions defined by the corresponding smart tag. Continuing the above example, if a browser application is configured to apply the smart tag of the sporting goods company, then when a web page is opened using the browser application, any occurrences of the terms basketball, football, hockey, baseball, soccer, etc., will be marked in some way. The user then can select (e.g., with a mouse click) one of the marked terms and select to link to the company's website.

Although hyperlinks and smart tags allow users to link one or more portions of a document to content not included in the document itself, neither enables a user to create the external content as part of process of creating or modifying the document itself. In both cases, the content is created first, and then the link is created to the content. Of course, a user could create the content concurrently to creating or modifying the document, but this would require running a separate application and/or editing a separate document, requiring the user to manually switch back and forth between the applications and/or documents.

### SUMMARY

Described herein are systems and methods for enabling a user to select at a region within a document (i.e., a region occupying only part of a document or occupying the entire document itself), and to specify the creation of content to link to the selected region. The user also may be enabled to specify to access and/or modify already-existing associated content linked to the selected region. The selected region may or may not include content (e.g., text). For example, the region may correspond to a section or field of the document within which a user may add, modify and/or delete content.

As used herein, “associated content” is content that is linked to a region within a document, but is not part of the content of the body of the document itself. In response to the user specifying to create, access (e.g., read-only) or edit associated content for a region within the document, a separate window may be launched that enables the user to access, create and/or edit the associated content. As used herein, a “window” is a bounded display area of a user interface in which information is displayed to a user, and in which a user may be allowed to enter or change information. This separate window may be a pane or panel within a user interface display of the application within which the document is being edited (i.e., an internal window), or may be a window external to the user interface display. Such a separate window (whether internal or external) is referred to herein as a “associated content window.”

A selected region of a document may correspond to any of a plurality of types of portions of a document, including, but not limited to: one or more spaces, a character; a word; a sentence fragment; a sentence; a paragraph; a section; a header; a footnote; a heading; another type of portion; or any suitable combination of the foregoing. The associated content may include any of a plurality of types of content, including, but not limited to: text; audio; video; images; tables; spreadsheets; files; data; objects; other types of software abstractions; software code; software scripts; hyperlinks; smart tags; other types of content; or any suitable combination of the foregoing. The associated content may include any information such as, for example, information relating to the region of the document with which it is associated (e.g., user assistance).

As is described in more detail below, associated content may be stored in a same file (or other software abstraction) as the region of a document to which it links, or may be stored in a separate file. In some embodiments, if no link has already been established between a document and an associated content file, a user may specify a file (or other software abstraction) or create a file in which the associated content is or will be stored. A single associated content file may include a plurality of associated contents. Each associated content may be linked to one or more regions of a document, and two or more of these regions may be from different documents.

A link between the selected region of a document and the associated content may be maintained, for example, by creating and persisting a software abstraction that defines the relationship. For example, if the document is an XML document, the relationship may be defined by an XML tag, or if the document is capable of using bookmarks (e.g., a suitable version of Microsoft® Word), the relationship may be maintained using an electronic bookmark.

As is described in more detail below, associated content may be stored in a same file (or other software abstraction) as the region of a document to which it links, or may be stored in a separate file. In some embodiments, if no link has already been established between a document and an associated content file, a user may specify a file (or other software abstraction) or create a file in which the associated content is or will be stored. A single associated content file may include a plurality of associated contents. Each associated content may be linked to one or more regions of a document, and two or more of these regions may be from different documents.

A list of links to associated content may be defined and maintained for a given document, and the list may be presented to a user, for example, as part of a menu of a user interface display. Users may be enabled to navigate the list, re-organize the list and/or select links from the list. Certain users may be granted permission to edit the associated content corresponding to a link and/or delete the link, while other users may not be granted one or more of these permissions.

Users may be enabled to control the display of associated content within the associated content window. For example, after the creation and/or displaying of associated content in the associated content window in response to a user action, the user may control whether the associated content continues to be displayed. For example, the user may specify to clear the associated content window until other associated content is created or selected by a user, or may allow the associated content to continue to display until other content is created or selected by a user. One or more aspects of this display behavior may be configured as default behavior that can be changed by a user.

From within the document, a user may access associated content in any of a variety of ways. For example, the link corresponding to the associated content may be selected (e.g., from a list of links). Further, the associated content may be accessed in response to one or more user events such as, for example, hovering a mouse pointer over the region of a document linked to the associated content, clicking the mouse over the selected region, or other user events.

The associated content may be displayed in the associated content window concurrently to the display, in a separate window, of some or all of the linked region of the document. In some embodiments, in response to a user specifying to access, create and/or modify associated content for a region within the document, the associated content is displayed, but the active window remains the window in which the selected region is displayed, until the user selects the associated content window. Alternatively, the associated content window is made the active window is response to the user specifying to create, access and/or modify the associated content.

Associated content may be stored as part of one or more software abstractions such as, for example, files (e.g., an XML file), objects, records, tables, other types of software abstractions or any suitable combination of the foregoing. These software abstractions may be stored separately from a document with which they are linked (e.g., as two or more separate files) and/or may be stored within the document itself.

At least some of the associated content may be copied and pasted from the associated content window into the body of the document itself.

The systems and methods described herein may enable users to develop associated content (e.g., user assistance) for a document in a more collaborative and converging fashion than previously possible with known systems, as will be described in more detail below.

In an embodiment of the invention, content is associated with a document. A user is enabled to specify to create content to associate with a region within the document selected in a first window by the user. In response to the user specifying to create content, a second window separate from the first window is provided, and the user is enabled to create, in the second window, the content to associate with the selected region of the document.

In an aspect of this embodiment, the associated content defines assistance for users with respect to the region within the document.

In another aspect of this embodiment, the associated content is stored in a file separate from the file in which the document is stored.

In another aspect of this embodiment, the associated content and the document are stored in a same file.

In yet another aspect of this embodiment, a first link is created between the selected region and the created content.

In another aspect of this embodiment, a list of links including the first link is displayed, each link defining an association between a region within the digital document and content associated with the region.

In another aspect of this embodiment, a user is enabled to select one of the links from the link list and/or to modify the link list.

In another aspect of this embodiment, one or more user events are associated with the first link, and, in response to the occurrence of one of the one or more user events, the created content is displayed to a user.

In another aspect of this embodiment, the created content is displayed in a window separate from the first window.

In yet another aspect of this embodiment, enabling the user to create content in the second window includes enabling the user to create at least one of the following: video content, audio content, image content, and/or interact active content.

In another aspect of this embodiment, the associated content is shared by a plurality of documents, each document having a region linked to the associated content.

In another embodiment of the invention, a computer program product is provided. The product includes a computer-readable medium, and computer-readable signals stored on the computer-readable medium defining instructions that, as a result of being executed by a computer, instruct the computer to perform the method of the embodiment of the invention described in the preceding paragraphs and/or one or more aspects thereof described in the preceding paragraphs.

In another embodiment of the invention, a system is provided for associating content with a document. The system includes a user interface to enable a user to specify to create content to associate with a region within the document selected in a first window. The system also includes a controller to control, in response to the user specifying to create content, the user interface to provide a second window separate from the first window. The user interface is operative to enable the user to create, within the second window, the content to associate with the selected region of the document.

In an aspect of the embodiment, the associated content defines assistance for users with respect to the region within the document.

In another aspect of the embodiment, the associated content is stored in a file separate from a file in which the document is stored.

In another aspect of this embodiment, the associated content and the document are stored in a same file.

In yet another aspect of the embodiment, the controller is operative to create a first link defining an association between the selected region and the created content.

In another aspect of the embodiment, the user interface is operative to display a list of links including the first link, each link defining a relationship between a region within the digital document and content associated with the region.

In another aspect of the embodiment, the user interface is operative to enable a user to select one of the links from the link list and/or modify the link list.

In another aspect of the embodiment, the user interface is operative to associate one or more user events with the selected region such that, in response to the occurrence of one of the one or more user events involving the selected region, the created content is displayed to a user.

In another aspect of the embodiment, the user interface is operative to associate the one or more user events with the selected region such that, in response to the occurrence of one of the one or more user events involving the selected region, the created content is displayed to a user in a window separate from the first window.

In yet another aspect of the embodiment, the user interface is operative to enable a user to create, in the second window, associated content including at least one of the following: video content, audio content, image content, and/or interactive content.

In another aspect of the embodiment, the associated content is shared by a plurality of documents, each document having a region linked to the associated content.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1 is a diagram illustrating an example of a user interface display for creating, displaying and/or modifying associated content linked to one or more regions of a document, according to some embodiments of the invention;

FIG. 2 is a block diagram illustrating an example of a system for creating, displaying and/or modifying associated content linked to one or more regions of a document and/or for navigating to the one or more regions of the document, according to some embodiments of the invention;

FIG. 3 is a diagram illustrating an example of an associated content menu of a user interface display for selecting, creating and/or modifying associated content linked to one or more regions of a document and/or for navigating to the one or more regions, according to some embodiments of the invention;

FIG. 4 is a flowchart illustrating an example of a method of creating, displaying and/or modifying associated content linked to one or more regions of a document and/or for navigating to the one or more regions of the document, according to some embodiments of the invention;

FIG. 5 is a flowchart illustrating an example of a method of creating associated content for a region within a document, according to some embodiments of the invention;

FIG. 6 is a flowchart illustrating an example of a method of using a list of links to display associated content and navigate to a region of a document, according to some embodiments of the invention;

FIG. 7 is a block diagram illustrating an example of a computer system on which some embodiments of the invention may be implemented; and

FIG. 8 is a block diagram illustrating an example of a storage system that may be used as part of the computer system to implement some embodiments of the invention.

### DETAILED DESCRIPTION

Although some embodiments are described herein primarily in relation to selecting a region of a document and associating content thereto, it should be appreciated that the invention is not so limited. Embodiments of the invention include selecting the entire document and associating content with the entire document. Further, although some embodiments of the invention are described primarily in relation to the associated content being user assistance, it should be appreciated that the invention is not so limited. The associated content may include any type of subject matter.

Although several embodiments described herein are described in relation to applications of the Microsoft® Office suite of applications, it should be appreciated that the invention is not so limited. Embodiments of the invention may be implemented using other applications and other types of applications.

The function and advantage of these and other embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition, Revision 2, May 2004), Section 2111.03.

### EXAMPLES

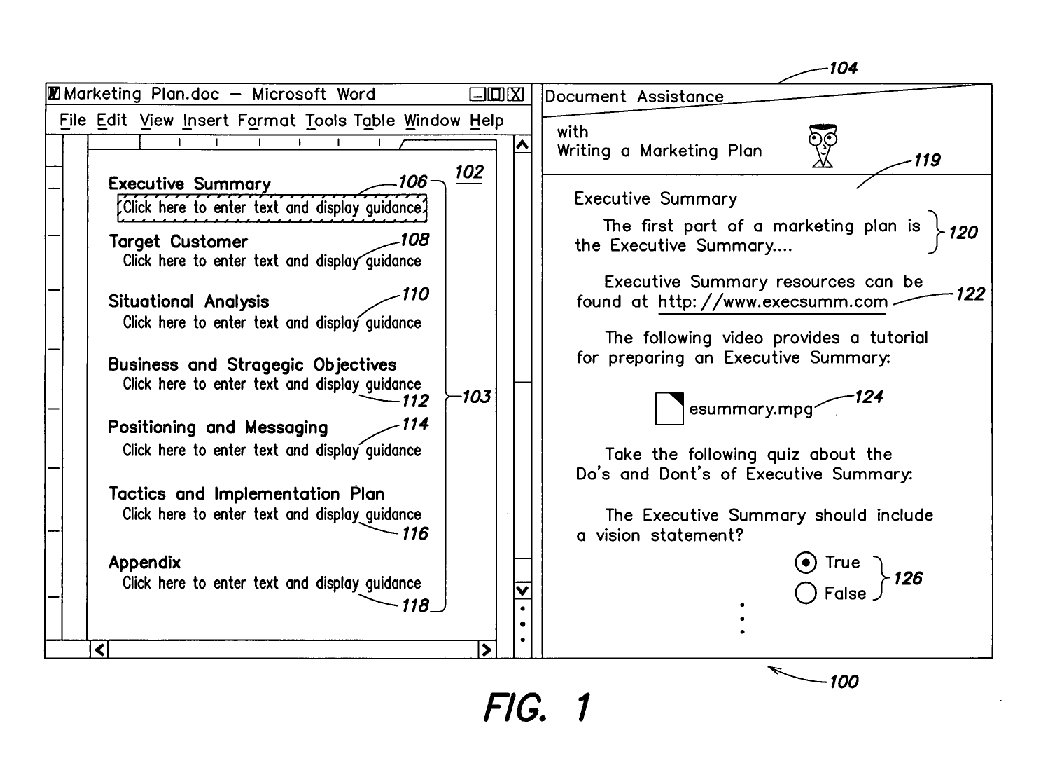

FIG. 1 is a diagram illustrating an example of a user interface display 100 for creating, displaying and/or modifying associated content linked to one or more regions of a document, according to some embodiments of the invention. Display 100 will now be described briefly to provide context for embodiments of the invention described below in more detail, and will be referred to frequently throughout the application. However, display 100 is merely an illustrative embodiment of a user interface display for creating, displaying and/or modifying associated content linked to one or more regions of a document, and is not intended to limit the scope of the invention. Any of numerous other implementations of such a display, for example, variations of display 100, are possible and are intended to fall within the scope of the invention.

As used herein, a “user interface” is an application or part of an application (i.e., a set of computer-readable instructions) that enables a user to interface with an application during execution of the application. A user interface may include code defining how an application outputs information to a user during execution of the application, for example, visually through a computer screen or other means, audibly through a speaker of other means, and manually through a game controller or other means. Such user interface also may include code defining how a user may input information during execution of the application, for example, audibly using a microphone or manually using a keyboard, mouse, game controller, track ball, touch screen or other means.

The user interface may define how information is visually presented (i.e., displayed) to the user, and defines how the user can navigate the visual presentation (i.e., display) of information and input information in the context of the visual presentation. During execution of the application, the user interface may control the visual presentation of information and enable the user to navigate the visual presentation and enter information in the context of the visual presentation. Types of user interfaces range from command-driven interfaces, where users type commands, menu-driven interfaces, where users select information from menus, and combinations thereof, to GUIs, which typically take more advantage of a computer's graphics capabilities, are more flexible, intuitive and easy to navigate and have a more appealing “look-and-feel” than command-driven and menu-driven visual user interfaces. As used herein, the visual presentation of information presented by a user interface or GUI is referred to as a “user interface display” or a “GUI display”, respectively.

Display 100 may include document window 102, associated content window 104 and other elements. Document window 102 may display regions 106-118 of document 103, one or more of which may be linked to associated content such as, for example, associated content 119 or a particular section thereof appearing in associated content window 104. Associated content 119 may include any of a variety of types of content, including any of those types described herein such as, for example, textual content 120, hyperlink content 122, video content 124 and interactive content 126 (content that enables a user to take one or more actions on the content, in response to which the content may take one or more actions).

In FIG. 1, document 103 may be a form or template to be filled in by a user. During the creation of the form, each of regions 106-118 may have been linked to associated content 119 or a respective section thereof. The associated content 119 may contain information designed to assist users in providing content within any of regions 106-118, or may include other types of information.

For example, document 103 may be a form for preparing a marketing plan, and associated content 119 may provide user assistance in preparing a marketing plan. Region 106 under heading “Executive Summary” may be linked to the section of associated content 119 that provides user assistance in drafting the Executive Summary of a marketing plan. Document window 102 may be configured such that, if a user selects region 106 and/or moves a cursor into region 106, then associated content 119 is displayed in associated content window 104. Depending on the permissions granted to the user, the user may be enabled to modify associated content 119. For example, if the user is one of a group of users that prepared the form document 103, then the user may be enabled to modify the associated content 119. Other users (e.g., users that use form document 103 to prepare a marketing plan) may not be enabled to modify associated content 119.

Having now provided some context, systems and methods for associating content with regions of a document will now be described. These systems and methods may enable users to develop associated content (e.g., user assistance) for a document in a more collaborative and converging fashion than previously realized with known systems. The development process is more collaborative because, as will be shown below, users can record their knowledge as associated content to a document, thus passing down their knowledge to futures users. Convergence occurs as future users add to, refine and improve the associated content over time.

For example, a first user may design and create a form, specifying one or more regions for which to create associated content, and possibly specifying the target of the associated content. A subject matter expect (SME) then may go through the form, updating the associated content for each region with general information that the SME thinks is pertinent. A next user then may use the form to prepare a document, acknowledging that the SME is correct with respect to the pertinent material, and updating the associated content with more detailed information, for example, information providing a clearer understanding of the information required for regions of the form. Another user then may use the form and refine the associated content provided by the previous user, and possibly update the associated content based on a change in company policy. Several later users then may use the form without the need to revise the associated content at all. Then a next user may update the associated content based on a change in government regulations, etc. It should be appreciated that the foregoing is merely an example of a collaborative and converging process that may be undertaken using embodiments of the invention, and is not intended to limit the scope of the invention. Other processes may be implemented using embodiments of the invention.

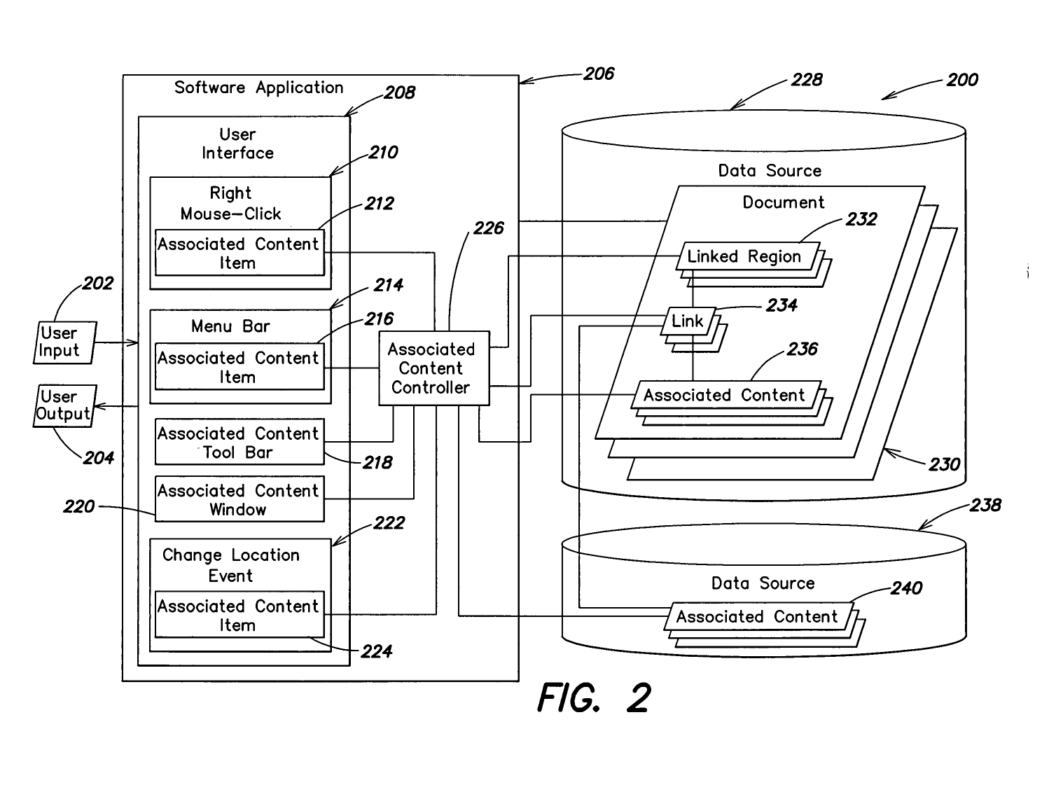

FIG. 2 is a block diagram illustrating an example of a system 200 for creating, displaying and/or modifying associated content linked to one or more regions of a document and/or for navigating to the one or more regions of the document, according to some embodiments of the invention. System 200 is merely an illustrative embodiment of a system for creating, displaying and/or modifying associated content linked to one or more regions of a document and/or for navigating to the one or more regions of the document, and is not intended to limit the scope of the invention. Any of numerous other implementations of such a system, for example, variations of system 200, are possible and are intended to fall within the scope of the invention.

System 200 may include any of software application 206, one or more data resources 228 and 238, one or more other elements, or any suitable combination of the foregoing. Data resource 230 may have one or more documents 230 stored thereon. Each document 230 may include one or more links 234 defining associations between one or more linked regions 232 of the document. Further, for each document 230, associated contents may include one or more associated contents 240 stored externally to the document. For each document 230, associated contents may include one more associated contents 236 stored within the document and one or more associated contents 240 stored externally to the document.

In embodiments where the associated content 236 is stored in the same document 230 as the linked regions 232 corresponding to the associated content, the associated content 236 may be used only for document 230. That is, the associated content 236 may be accessed, created and/or modified only from within document 230.

In other embodiments, where the associated content 240 is located externally to the document having the linked regions 232 corresponding to the associated content 240, the associated content 240 may be shared among a plurality of documents. That is, the associated content 240 may be accessed, created and/or modified from within a plurality of documents. For example, a template or form provided on a document server may be configured with one or more links 234 linking linked regions 232 to associated content 240 on a same or different server. Each time the template or form is used by a user to create a new document (e.g., document 103), the new document includes (at least initially) links linking the same linked regions to the associated content 240.

For example, some applications such as, for example, Microsoft® Word, have reserved areas (e.g., document variables and/or document properties for storing information that enable the application to be customized and/or extended. The software abstractions defining the associated content may be defined within these reserved areas.

Each of links 234 may be implemented in any of a variety of ways, including any ways described herein. In essence, a link defines a reference to associated content, for example, by specifying a target. In embodiments where the associated content is stored within the document itself, the target may specify another location with the document. In other embodiments where the associated content is stored externally, the target may specify another location on a computer and/or a network address, for example using a Uniform Resource Locator (URL).

Each link 234 may be implemented in any of a variety of ways. For example, a link may be implemented using XML tags underlying a document. If the software application is a suitable version of Microsoft® Word, a link may be implemented by the “Bookmark” feature. That is, each link may be implemented as a Bookmark, which may refer to an XML tag that specifies the target. Other techniques may be used.

Each document 230 may be any of a variety of types of documents, including, but not limited to: an HTML document, and XML documents, a Microsoft® Word document or another type of word-processing document; a spreadsheet document (e.g., MicroSoft® Excel document); an email message; a web page; a presentation document (e.g., MicroSoft® Power Point® document); another type of document; or any suitable combination of the foregoing.

Software application 206 may be any of a variety of types of software applications, for example, any of the Microsoft® Office suite of applications. Software application 206 may include a user interface 208 configured to receive user input 202 and provide user output 204, associated content controller 226, other elements, or any suitable combination of the foregoing.

User interface 208 may include any of: right mouse-click component 210; menu bar component 214, associated content toolbar 218; associated content window 220; change location event module 222; other modules; or any suitable combination of the foregoing. Right mouse-click module 210 may be configured to control the options provided to a user in response to a right mouse-click event. Module 210 may include an associated content item 212, which may be configured to be selectable by a user to perform one or more operations corresponding to associated content of a region of a document.

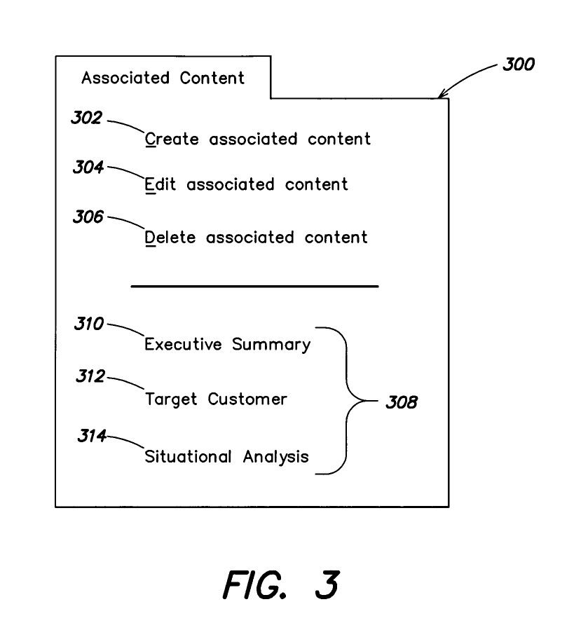

Digressing briefly from FIG. 2, FIG. 3 is a diagram illustrating an example of an associated content menu 300 that may be provided by associated content item 212. Menu 300 is merely an illustrative embodiment of a menu for selecting, creating and/or modifying associated content linked to one or more regions of a document and/or for navigating to the one or more regions, and is not intended to limit the scope of the invention. Any of numerous other implementations of such a menu, for example, variations of menu 300, are possible and are intended to fall within the scope of the invention

Menu 300 may include any of: create associated content item 302; edit associated content item 304; delete associated content item 306; associated content links list 308; other items; or any suitable combination thereof.

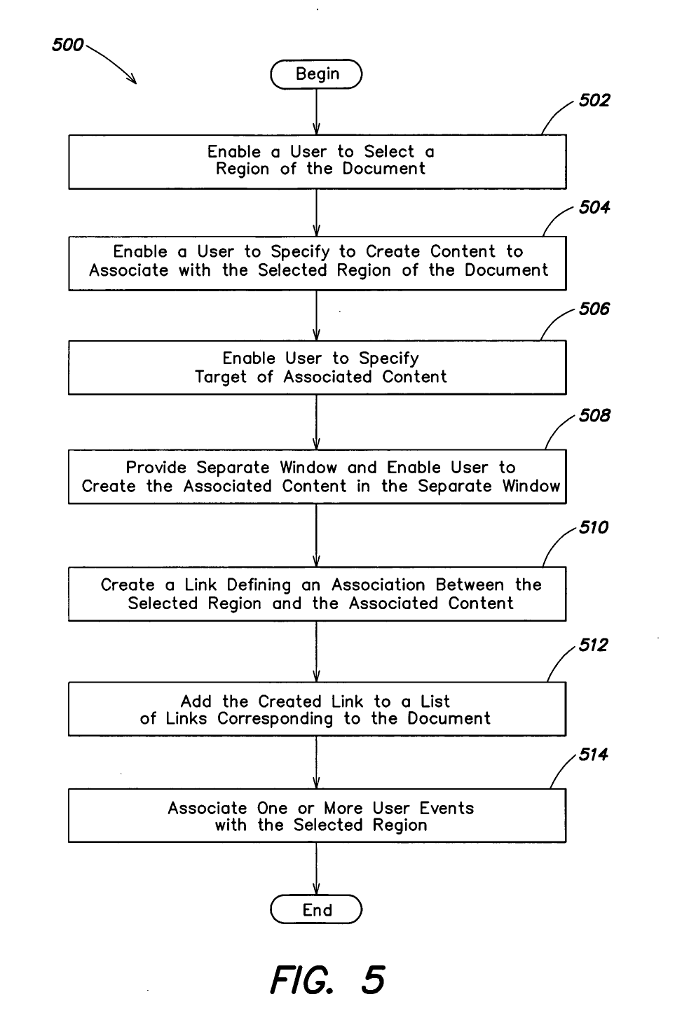

Create associated content item 302 may be configured such that, if a user selects item 302, the user can create associated content for a region of a document. Item 212 may be configured to communicate with associated content controller 226 in response to a user selecting create associated content item 302 to create associated content for a region of a document. The creating of the associated content may involve any of Acts 506-514 described below in relation to method 500 shown in FIG. 5.

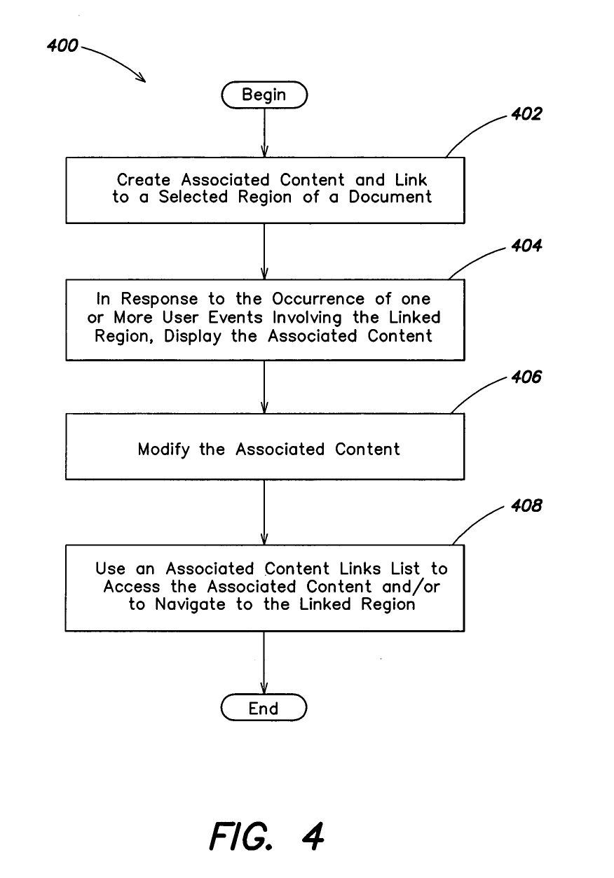

Edit associated content item 304, when selected by a user 304, may communicate with associated controller 226 to enable a user to modify associated content corresponding to a region of a document, for example, as described below in relation to Act 406 of method 400 shown in FIG. 4. Item 304 may be configured to only be available to a user if the user has selected a region of a document for which associated content already exists. Similarly, delete associated content item 306 may be provided as an option to a user only if a region of the document selected by the user already has associated content. Item 306 may be configured such that, in response to a user selecting item 306, item 306 communicates with associated content controller 226 to enable a user to delete associated content of a selected region.

Links list 308 may include a list of links 310, 312 and 314 between regions of a document and associated content. For example, links 310, 312 and 314 may correspond to regions 106, 108 and 110 of document 103 shown in FIG. 1. Each of items 310, 312 and 314 may be configured such that, in response to a user selecting the item, the associated content corresponding to the link may be displayed in an associated content window (e.g., window 104) and/or the focus in the document window (e.g., window 102) may change focus to the region of the document corresponding to the selected link.

It should be appreciated that associated content menu 300 may include additional items providing additional functionality.

Returning to FIG. 2, menu bar module 214 may be configured to provide a menu bar including one or more menu items to a user. In some embodiments, menu bar module 214 may include an associated content item 216 that is selectable by a user. Associated content item 216 may be configured to provide a menu of options corresponding to associated content to a user in response to the user selecting item 216 from menu bar 214. For example, item 216 may be configured to provide a menu similar to or the same as menu 300 described above in relation to FIG. 3.

User interface 208 may be configured to include an associated content toolbar 218, which may include one or more tools for performing operations corresponding to associated content. For example, toolbar 218 may provide a plurality of icons, each icon representing a different function such as, for example, any of the functions described above in relation to menu 300. Each tool appearing on toolbar 218 may be configured to communicate with associated content controller 226 to perform the function associated with the tool in response to the user selecting the tool.

Associated content window 220 may be configured (e.g., in conjunction with controller 226) to provide an associated content window (e.g., window 104). Module 220 may be configured to display associated contents, and may be configured to enable users having certain permissions to create and/or modify the associated content displayed within the associated content window. The software application 206 and/or the operating system on which software application 206 is configured to be executed may be configured with a file management rights system that controls read and write access to files for users of the operating system. Associated content window 220 and/or controller 226 may be configured to utilize this file management system in determining permissions for users to access, create and/or modify associated content.

Change location event module 222 may be configured to capture any change in location of a cursor on the user interface display (e.g., in response to a mouse or keyboard event). For example, if software application is a version of Microsoft® Word, change location event module 222 may utilize the ChangeLocation event to capture location changes. Module 222 may include an associated content item 224 that may perform one or more operations in response to a change in location that results in the cursor residing in a linked region of a document. For example, item 224 may be configured to communicate with controller 226 to change the associated content displayed in associated content window (e.g., 104) in response to the cursor changing location to a linked region. Further, item 224 may be configured to provide a menu of options (e.g., menu 300) to a user in response to a change of location to a linked region of a document. Associated content item 224 may be implemented by utilizing hooks provided by an API such as, for example, hooks to the ChangeLocation event.

Components 212, 216, 218, 220, 224 and 226 may be embedded within software application 206, or may be implemented as an add-in component to software application 206.

FIG. 4 is a flow chart illustrating an example of a method 400 of creating, displaying and/or modifying associated content linked to one or more regions of a document and/or for navigating to the one or more regions of the document, according to some embodiments of the invention. Method 400 is merely an illustrative embodiment of a method of creating, displaying and/or modifying associated content linked to one or more regions of a document and/or for navigating to the one or more regions of the document, and is not intended to limit the scope of the invention. Any of numerous other implementations of such a method, for example, variations of method 400, are possible and are intended to fall within the scope of the invention.

In Act 402, associated content may be created and linked to a selected region of a document, for example, as described above and/or as described below in relation to method 500 shown in FIG. 5.

In Act 404, in response to the occurrence of one or more user events involving the linked region, the associated content of the linked region may be displayed, for example, as described above (e.g., in relation to change location event module 222 of system 100 shown in FIG. 2).

In Act 406, the associated content may be modified, for example, as described above in relation to system 200.

In Act 408, an associated content links list may be used to access the associated content and/or to navigate to the linked region. For example, links list 308 of menu 300 may enable a user to select an associated content link, resulting in the display of the associated content in an associated content window (e.g., window 104). Further, links list 308 may be configured such that, in response to a user selecting a link from the list, focus of the document window is moved to the location within the document of the linked region corresponding to the selected link.

Method 400 may include additional acts. Further, the order of the acts performed as part of method 400 is not limited to the order illustrated in FIG. 4, as the acts may be performed in other orders and/or one or more of the acts may be performed in series or in parallel (at least partially). For example, although method 400 illustrates Acts 402-408 occurring in series, it should be appreciated that method 400 may be implemented using event-based techniques, in which one or more of Acts 402-408 are performed in response to one or more events, not necessarily in the sequence illustrated in FIG. 4. Further, Acts 404-408 may be performed in any order after the associated content has been created in Act 402.

FIG. 5 is a flow chart illustrating an example of a method 500 of creating associated content for a region within a document. Method 500 is merely an illustrative embodiment of a method of creating associated content for a region within a document, and is not intended to limit the scope of the invention. Any of numerous other implementations of such a method, for example, variations of method 500, are possible and are intended to fall within the scope of the invention.

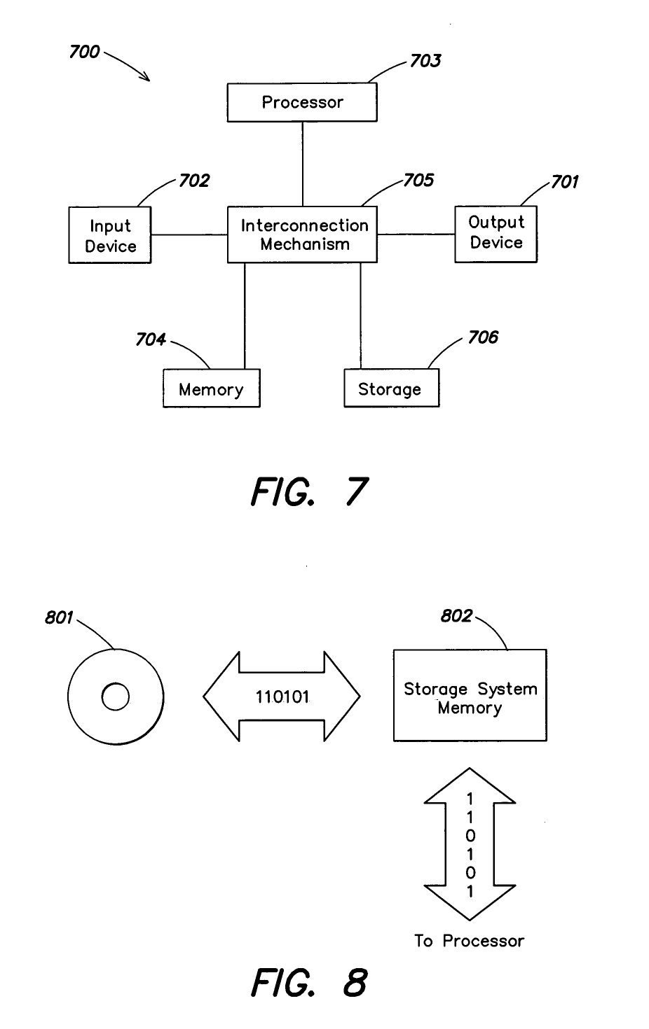

Further, on each of the one or more devices that include one or more components of system 200, each of the components may reside in one or more locations on the system. For example, different portions of the components of system 200 may reside in different areas of memory (e.g., RAM, ROM, disk, etc.) on the device. Each of such one or more devices may include, among other components, a plurality of known components such as one or more processors, a memory system, a disk storage system, one or more network interfaces, and one or more busses or other internal communication links interconnecting the various components. System 200 and components thereof may be implemented using a computer system such as that described below in relation to FIGS. 7 and 8.

In Act 502, a user may be enabled to select a region within a document within a first window. For example, using functionality commonly found in software applications (e.g., clicking and dragging a mouse and/or pressing a combination of keys on a keyboard), the user may select an entire document or any of a plurality of the types of portions of a document described above. Further, the user may be enabled to select a region of a document for which to create associated content using a tool (e.g., provided by associated content toolbar 218) provided by a user interface.

In Act 504, the user may be enabled to specify to create content to associate the selected region of the document. For example, a menu bar (e.g., provided by menu bar module 214) of an application may include a menu item (e.g., associated content item 216) for associating content with a selected region of a document, and a user may be enabled to select the menu items. This menu (e.g., 300) may include any of a plurality of associated content items, including a list of (e.g., 308) associated content links, an item (e.g., item 302) to add a link and associated content. The user may be enabled to select the item for adding (i.e., creating) a link and associated content. Alternatively, or in addition to, providing such a menu item in a menu bar, a similar or same menu may be provided the user in response to a particular user event such as, for example, a right mouse-click over the selected region of the document. Such a menu may be provided by associated content item 212 of right mouse-click module 200. Further, an item of an associated content tool bar (e.g., tool bar 218) may enable a user to specify to create associated content. Other techniques may be used.

In Act 506, the user may be enabled to specify a target of the associated content, for example, as described above.

In Act 508, in response to the user specifying to create associated content, a separate window (e.g., window 104) within which to create content to associate with the selected region may be provided. As described above, this separate window (i.e., associated content window) may be situated internally or externally to a user interface in which the document is displayed and edited by the user. For example, the application presenting the user interface may be configured to launch the separate window as a pane or panel within the user interface. Alternatively, if the application is not so configured, the associated content window may be launched external to the user interface of the application, for example, as shown in FIG. 1.

The user then may create the associated content in the associated content window. The user may be enabled to create any of a variety of types of content such as, for example, any of the variety of types described above, including textual content, video content, image content, interactive content, hyperlinks, other types of content, and any suitable combination of the foregoing. Further, the subject matter of the content may be any of a variety of types of subject matter, including, but not limited to, user assistance corresponding to the selected region of the document. When the user is done creating the content, the user may specify that the content be saved, for example, by selecting an appropriate menu item or button on a user interface display.

In Act 510, a link for the selected region of the document may be created, the link defining an association between a selected region and the created content. Such a link may be a software abstraction that defines the association between the selected region and the created content. For example, as described above in relation to system 200, if the document is an XML document, the relationship may be defined by an underlying XML tag that specifies a target at which the associated content is located. If the document is a document capable of using bookmarks (e.g., a suitable version of MicroSoft® Word), the relationship may be maintained using a bookmark that references an XML tag that specifies a target. Other types of software abstractions may be used.

In Act 512, the created link may be added to a list of links corresponding to the document. Such a list may be stored within a document, and may be used to provide an associated links list within an associated content menu (e.g., menu 300).

The created associated content may be saved using one or more software abstractions such as, for example, objects, records, tables, etc. As described above in relation to system 200, these software abstractions may be stored separately from the document with which they are associated, or, alternatively, the software abstractions may be stored within the document itself. For example, some applications such as, for example, MicroSoft® Word, have reserved areas for storing information that enable the application to be customized and/or extended. The software abstractions defining the associated content may be defined within these reserved areas.

In Act 514, one or more user events may be associated with the link created for the selected region. Such user events may include, but are not limited to, a mouse-over event, or a mouse-click event. Such events may be associated using hooks provided by an application programming interface (API) of the operating system of the computer on which the software application is being executed. As used herein, an “application programming interface” or “API” is a set of one or more computer-readable instructions that provide access to one or more other sets of computer-readable instructions that define functions, so that such functions can be configured to be executed on a computer in conjunction with an application program. An API may be considered the “glue” between application programs and a particular computer environment or platform (e.g., any of those discussed below) and may enable a programmer to program applications to run on one or more particular computer platforms or in one or more particular computer environments.

As a result of associating the user events one or more acts may be taken in response to the occurrence of one or more of the user events that involves the selected region, for example, as described above in relation to Act 404 of method 400.

Method 500 may include additional acts. Further, the order of the acts performed as part of method 500 is not limited to the order illustrated in FIG. 5, as the acts may be performed in other orders and/or one or more of the acts may be performed in parallel (at least partially). For example, at least portions of Acts 502-506 may be performed in parallel. Further, Acts 508, 510 and 514 may be performed in any order and/or in parallel.

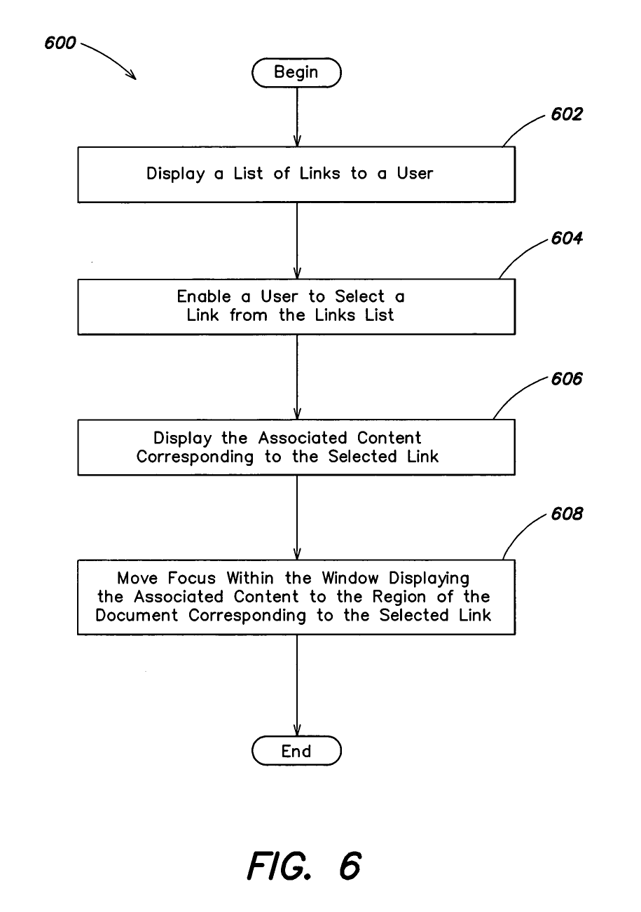

FIG. 6 is a flow chart illustrating an example of a method 600 of using a list of links to display associated content and navigate to a region of a document, according to some embodiments of the invention. Method 600 is merely an illustrative embodiment of a method of using a list of links to display associated content and navigate to a region of document, and is not intended to limit the scope of the invention. Any of numerous other implementations of such a method, for example, variations of method 600, are possible and are intended to fall within the scope of the invention.

In Act 602, the list of links may be displayed to a user, for example, in a drop-down menu (e.g., menu 300) from a menu item of the menu bar or within a menu (e.g., menu 300) presented to a user in response to a right mouse-click. In Act 604, the user may be enabled to select a link from the list of links.

In response to a user selecting a link from the list of links, the user may be presented with one or more options with respect to the selected link. For example, the user may have the option of displaying and/or editing the associated content corresponding to the selected link. Further, the user may be presented with the option of moving the user focus to the region of the document corresponding to the selected link.

In Act 606, in response to a user selection, the associated content corresponding to a selected link may be displayed in an internal or external associated content window (e.g., window 104).

In Act 608, in response to a user selection, user focus may be moved from the current location of the document being displayed in the document window (e.g., window 102) to the region of the document corresponding to the selected link. For example, a user may have been on page 4 of a document when the list of links was presented to the user. In response to the user selecting a link corresponding to region of the document on page 10, the user focus of the application may move to the region on page 10.

Method 600 may include additional Acts. Further, the order of the acts performed as part of Method 600 is not limited to the order illustrated in FIG. 6, as the acts may be performed in other orders and/or one or more of the acts may be performed in parallel (at least partially). For example, at least parts of Acts 606-608 may be performed in parallel. Further, Act 604 or portions thereof may be performed before or in parallel to the performance of Act 602.

Methods 400-600, acts thereof and various embodiments and variations of these methods and acts, individually or in combination, may be defined by computer-readable signals tangibly embodied on or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein (e.g., method 400, 500 or 600 or any acts thereof), and/or various embodiments, variations and combinations thereof. Such instructions may be written in any of a plurality of programming languages, for example, Java, J#, Visual Basic, C, C#, or C++, Fortran, Pascal, Eiffel, Basic, COBOL, etc., or any of a variety of combinations thereof. The computer-readable media on which such instructions are embodied may reside on one or more of the components of any of systems 200, 700 and 800 described herein, may be distributed across one or more of such components, and may be in transition therebetween.

The computer-readable media may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described in relation to FIGS. 7 and 8, that perform the functions described herein can be generically considered as one or more controllers that control such functions. The one or more controllers can be implemented in numerous ways, such as with dedicated hardware and/or firmware, using a processor that is programmed using microcode or software to perform the functions recited above or any suitable combination of the foregoing.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to convert text to speech and/or edit speech on a portable audio device according to various embodiments of the invention. Further, the software design system may be located on a single computer or may be distributed among a plurality of computers attached by a communications network.

A general-purpose computer system according to one embodiment of the invention is configured to perform convert text to speech and/or edit speech on a portable audio device. It should be appreciated that the system may perform other functions and the invention is not limited to having any particular function or set of functions.

For example, various aspects of the invention may be implemented as specialized software executing in a general-purpose computer system 700 such as that shown in FIG. 7. The computer system 700 may include a processor 703 connected to one or more memory devices 704, such as a disk drive, memory, or other device for storing data. Memory 704 is typically used for storing programs and data during operation of the computer system 700. Components of computer system 700 may be coupled by an interconnection mechanism 705, which may include one or more busses (e.g., between components that are integrated within a same machine) and/or a network (e.g., between components that reside on separate discrete machines). The interconnection mechanism 705 enables communications (e.g., data, instructions) to be exchanged between system components of system 700. Computer system 700 also includes one or more input devices 702, for example, a keyboard, mouse, trackball, microphone, touch screen, and one or more output devices 701, for example, a printing device, display screen, speaker. In addition, computer system 700 may contain one or more interfaces (not shown) that connect computer system 700 to a communication network (in addition or as an alternative to the interconnection mechanism 705.

The storage system 706, shown in greater detail in FIG. 8, typically includes a computer readable and writeable nonvolatile recording medium 801 in which signals are stored that define a program to be executed by the processor or information stored on or in the medium 801 to be processed by the program. The medium may, for example, be a disk or flash memory. Typically, in operation, the processor causes data to be read from the nonvolatile recording medium 801 into another memory 802 that allows for faster access to the information by the processor than does the medium 801. This memory 702 is typically a volatile, random access memory such as a dynamic random access memory (DRAM) or static memory (SRAM). It may be located in storage system 706, as shown, or in memory system 704, not shown. The processor 703 generally manipulates the data within the integrated circuit memory 704, 802 and then copies the data to the medium 801 after processing is completed. A variety of mechanisms are known for managing data movement between the medium 801 and the integrated circuit memory element 704, 802, and the invention is not limited thereto. The invention is not limited to a particular memory system 704 or storage system 706.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 700 is shown by way of example as one type of computer system upon which various aspects of the invention may be practiced, it should be appreciated that aspects of the invention are not limited to being implemented on the computer system as shown in FIG. 7. Various aspects of the invention may be practiced on one or more computers having a different architecture or components that that shown in FIG. 7.

Computer system 700 may be a general-purpose computer system that is programmable using a high-level computer programming language. Computer system 700 may be also implemented using specially programmed, special purpose hardware. In computer system 700, processor 703 is typically a commercially available processor such as the well-known Pentium class processor available from the Intel Corporation. Many other processors are available. Such a processor usually executes an operating system which may be, for example, the Windows® 95, Windows® 98, Windows NT®, Windows® 2000 (Windows® ME) or Windows® XP operating systems available from Microsoft Corporation, MAC OS System X available from Apple Computer, the Solaris Operating System available from Sun Microsystems, UNIX available from various sources or Linux available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, J# (J-Sharp) or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of associating content with a document, comprising acts of:
(A) enabling a user to specify to create content to associate with a region within the document selected in a first window by the user; and
(B) in response to the user specifying to create content, providing a second window separate from the first window, and enabling the user to create, in the second window, the content to associate with the selected region of the document,
wherein the associated content defines assistance for users with respect to the region within the document.

2. The method of claim 1, further comprising:
(C) storing the associated content in a file separate from the file in which the document is stored.

3. The method of claim 2, further comprising:
(C) storing the associated content and the document in a same file.

4. The method of claim 1, further comprising an act of:
(C) creating a first link between the selected region and the created content.

5. The method of claim 3, further comprising an act of:
(D) displaying a list of links including the first link, each link defining an association between a region within the digital document and content associated with the region.

6. The method of claim 5, further comprising an act of:
(E) enabling a user to select one of the links from the link list and/or to modify the link list.

7. The method of claim 4, further comprising an act of:
(D) associating one or more user events with the first link; and
(E) in response to the occurrence of one of the one or more user events, displaying the created content to a user.

8. The method of claim 7, wherein the act (C) comprises displaying the content in a window separate from the first window.

9. The method of claim 1, wherein the act (B) includes enabling the user to create content including at least one of the following: video content, audio content, image content, and/or interact active content.

10. A system for associating content with a document, comprising:
a user interface to enable a user to specify to create content to associate with a region within the document selected in a first window; and
a controller to control, in response to the user specifying to create content, the user interface to provide a second window separate from the first window, wherein the user interface is operative to enable the user to create, within the second window, the content to associate with the selected region of the document,
wherein the associated content defines assistance for users with respect to the region within the document.

11. The system of claim 9, wherein the associated content is stored in a file separate from a file in which the document is stored.

12. The system of claim 10, wherein the controller is operative to create a first link defining an association between the selected region and the created content.

13. The system of claim 12, wherein the user interface is operative to display a list of links including the first link, each link defining a relationship between a region within the digital document and content associated with the region.

14. The system of claim 13, wherein the user interface is operative to enable a user to select one of the links from the link list and/or modify the link list.

15. The system of claim 12, wherein the user interface is operative to associate one or more user events with the selected region such that, in response to the occurrence of one of the one or more user events involving the selected region, the created content is displayed to a user.

16. The system of claim 15, wherein the user interface is operative to associate the one or more user events with the selected region such that, in response to the occurrence of one of the one or more user events involving the selected region, the created content is displayed to a user in a window separate from the first window.

17. The system of claim 10, wherein the user interface is operative to enable a user to create, in the second window, associated content including at least one of the following:
video content, audio content, image content, and/or interactive content.

18. The system of claim 15, wherein the associated content is shared by a plurality of documents, each document having a region linked to the associated content.

19. A computer program product comprising:
a computer-readable medium; and
computer-readable signals, stored on the computer-readable medium, that define instructions that, as a result of being executed by a computer, control the computer to perform a process of associating content with a document, comprising acts of:
(A) enabling a user to specify to create content to associate with a region within the document selected in a first window by the user; and
(B) in response to the user specifying to create content, providing a second window separate from the first window, and enabling the user to create, in the second window, the content to associate with the selected region of the document,
wherein the associated content defines assistance for users with respect to the region within the document.

20. The computer program product of claim 19, the process further comprising:
(C) storing the associated content in a file separate from the file in which the document is stored.
